(19) United States
(12) Patent Application Publication
(10) Pub. No.: US 2005/0073518 A1
(43) Pub. Date: Apr. 7, 2005

(54) Method and system for detecting a power status of a display device

(76) Inventor: Raymond Bontempi, Jamison, PA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/678,002

(22) Filed: Oct. 2, 2003

(51) Int. Cl. G09G 5/00

(52) U.S. Cl. 345/211

(57) ABSTRACT

A method for determining a power status includes detecting a current associated with a power source of a display device and determining the power status of the display device in accordance with the current.

### FIELD

The present method and system relate to detecting a power status of a display device. More particularly, the present method and system include determining a power status of a display device based on a current associated with the display device.

### BACKGROUND

In a typical cable television system, subscribers purchase or are provided a set-top box or terminal. The set-top terminal is a box of electronic equipment that is used to connect the subscriber's television, and potentially other electronic equipment, with a cable, satellite, or other broadband network. The set-top box is usually connected to the cable network through a co-axial wall outlet. The set-top box provides programming services to the subscriber's television.

The set-top box is essentially a computer that is programmed to process the signals from the cable network so as to provide the subscriber with cable services. However, the functionalities of conventional set-top box systems are limited because they cannot ascertain whether or not a user is actually watching the television. In many cases, users will turn off the television, but leave the set-top box powered “on.” Current set-tops are unaware of whether the television's power is “on” or “off,” and hence, whether the user is actually watching the output of the set-top box. Consequently, for many operations of the set-top box, the set-top box must assume that the television power is “on.” The set-top box must continue to transmit programming data, reminders, and messages for the television's use, even if the television power is “off.” In such a situation, the set-top box wastes energy and resources. Moreover, by not being aware of the power status of the television, the set-top box misses opportunities to execute functions that cannot be performed when the television is being watched.

Moreover, transmitted reminders and messages can interrupt a subscriber's recording of a television program. For example, the subscriber may set a reminder that is to be displayed on the television as notification to the user of an upcoming television program. If the subscriber chooses to leave the television “off,” record a program, and watch the program later, the preset reminder can interrupt the recording of the program. The conventional set-top box cannot tell that the television is “off” and will transmit the reminder, thereby interfering with the recording of the program by causing a reminder to be recorded on top of the content of the television program. Conventional set-top boxes can also interfere with the recording of a program by switching from a subscriber selected channel to an emergency alert system (EAS) channel in the event that an EAS signal is broadcast. In such a situation, the set-top box causes the EAS program to be recorded rather than the chosen program by switching the tuner to the EAS channel even though the television is “off.”

Traditional set-top boxes are further limited by the inability to determine the power status of the television. It is difficult for traditional set-top boxes to share resources with other devices that may be networked to the set-top box because the set-top box cannot safely reallocate its resources to a second television or video recorder unless it can determine that a once engaged television has been turned “off.”

Conventional set-top boxes are further limited by the inability to determine the power status of the television. The set-top boxes are typically forced to download code and messages from a head-end unit via a slower out-of-band frequency rather than by a faster in-band frequency because downloading by an in-band frequency requires the set-top box to switch away from ordinary television programming channels in order to perform the download. In order to avoid interfering with a subscriber's viewing of television program, conventional set-top boxes typically resort to downloading via a slower out-of-band frequency. In a television or network system, the capabilities and functionalities of a set-top box would be enhanced by configuring the set-top box to determine the power status of the television.

### SUMMARY

A method for determining a power status includes detecting a current associated with a power source of a display device and determining the power status of the display device in accordance with the current.

### BRIEF DESCRIPTION OF THE DRAWINGS

The accompanying drawings illustrate various embodiments of the present method and system and are a part of the specification. Together with the following description, the drawings demonstrate and explain the principles of the present method and system. The illustrated embodiments are merely examples of the present invention and do not limit the scope of the invention.

FIG. 1 illustrates an exemplary embodiment of an overall setup of a system configured to determine a power status of a display device.

FIG. 2 illustrates an exemplary embodiment of a setup of a system configured to determine power statuses of multiple display devices.

FIG. 3 illustrates an exemplary embodiment of an overall setup of a system configured to determine a power status of a display device.

FIG. 3 is a flow diagram illustrating an exemplary process for determining a power status of a display device.

### DETAILED DESCRIPTION

The present method and system relate to detecting a power status of a display device. More particularly, the present method and system include determining a power status of a display device based on an electrical current associated with the display device.

In the present specification and in the appended claims, a “detection device” is meant to be understood broadly as any electrical component that is configured to process a signal associated with a detection of an electrical current. The detection device may include, or be communicatively coupled to, an electrical component configured to receive and process a broadcast signal, such as a set-top box or a receiver unit that is configured to receive a signal from a head-end unit and process data associated with the received signal. The detection unit may subsequently transmit a signal to one or more display devices. The detection unit can be configured to communicate with the head-end unit. The detection unit can be any device associated with a display device such as a television, including but not limited to a set-top box, a receiver unit, a digital video recorder (DVR), a video cassette recorder (VCR), a digital video disc (DVD) player or recorder, a channel tuner, and the like. A “set-top box” is meant to be understood broadly as any device that enables a display device such as a television to receive and display programming or network services.

In the following description, for purposes of explanation, numerous specific details are set forth in order to provide a thorough understanding of the present method and system for configuring parameters of a detection device. It will be apparent, however, to one skilled in the art that the present method may be practiced without these specific details. Reference in the specification to “one embodiment,” “an embodiment,” or “an exemplary embodiment” means that a particular feature, structure, or characteristic described in connection with the embodiment is included in at least one embodiment. The phrases “in one embodiment” and “in an exemplary embodiment” appear in various places in the specification and are not necessarily all referring to the same embodiment.

Exemplary Overall Structure

Referring now to the drawings, FIG. 1 shows an exemplary setup (100) that includes a head-end unit (110) communicatively coupled to a detection device (120) by a transmission medium (115). Signals, including television programming services, can be transmitted from the head-end unit (110) to the detection device (120) via the transmission medium (115). The detection device (120) can also transmit signals to the head-end unit (110) via the transmission medium (115). As shown in FIG. 1, the detection device (120) is communicatively coupled to a display device (130) by a transmission medium (125). The display device (130) is coupled to a power source (140) by a power transmission medium (135). The detection device (120) is communicatively coupled to a sensor (150) by a transmission medium (145). The sensor (150) is coupled to the power transmission medium (135). While FIG. 1 shows the sensor (150) coupled to the power transmission medium (135), the sensor (150) may be coupled to the power source (140), the display device (130), or to the power transmission medium (135) at any location between the power source (140) and the display device (130). The elements of the exemplary setup (100) shown in FIG. 1 will now be discussed in further detail below.

As shown in FIG. 1, signals are transmitted from the head-end unit (110) to the detection device (120). The head-end unit (110) can be any signal broadcaster capable of communicating with the detection device (120) via the transmission medium (115), including but not limited to, a facility or component at a signal production office that communicates television, modem, or other services (collectively “services”) to subscribers. The services may include, but are in no way limited to, satellite, cable, analog, digital, or other type of television or network services. A network operator may broadcast signals and messages from the head-end unit (110) to subscribers' detection devices (120).

The head-end unit (110) typically includes a satellite dish antenna for receiving incoming programming and message signals from a broadcasting station that broadcasts services. The service signals may be transmitted to the head-end unit (110) in a number of ways including, but not limited to, a satellite dish, a fiber-optic cable, a coaxial cable, a phone line, a wireless medium, and the like. The head-end device (110) then transmits signals to the detection device (120) via the transmission medium (115). The transmission medium (115) is any medium capable of carrying communications from the head-end unit (110) to the detection device (120), including but not limited to a coaxial cable, a fiber-optic cable, a phone line, a medium for propagating wireless communications, and the like.

The detection device (120) receives and processes the service signals. The detection unit (120) can be any circuitry or programmable device configured to receive broadcast signals and process data associated with the received signals. The detection device (120) may be associated with television or network services, including cable or satellite television services. In one exemplary embodiment, the detection device (120) is a set-top box (STB) associated with cable television services.

The detection unit (120) may be configured or programmed to control features and services that are made available to the display device (130). The detection unit (120) can comprise processors, memory, peripherals, computer-readable mediums, input devices, output devices, transmitters, receivers, processor readable carriers, or any other computer-related component. The detection unit (120) may contain modules that process the service signals and messages to control the functions and operations of the detection unit (120). The detection unit (120) may be configured or programmed to control what signals and features are made available to a display device (130). In an exemplary embodiment, a level detection module interfaces with a CoreTV module to control operations and programming of the detection device (120).

As shown in FIG. 1, the detection device (120) is communicatively coupled to a display device (130), such as a television. The detection unit (120) enables the display device (130) to receive and display television, network, or other services. The detection device (120) controls the signals, data, and operations related to the transmission of services to the display device (130). The display device (130) can be any device capable of displaying, recording, or processing television or network services, including but not limited to a television, a computer monitor, a flat-panel screen, a digital video recorder (DVR), a video cassette recorder (VCR), a digital video disc (DVD) player, and the like. In an exemplary embodiment, the display device (130) is a television.

The display device (120) is coupled to the power source (140) via the power transmission medium (135). The display device is configured to draw power from the power source (140). The power source (140) may be any source of power, such as electrical power, that is capable of supplying power to the display device (130), including but not limited to an alternating current (AC) source, a direct current (DC) source, a power generator, a battery, an automobile, and the like. In an exemplary embodiment, the power source (140) is a connection to a supply of AC power, such as a power outlet, that is capable of powering a television. The power transmission medium (135) can be any medium capable of transmitting power, such as electrical power, from the power source (140) to the display device (130) or to the detection device (120), including but not limited to a power cord, a wire, a conductive medium, and the like.

As shown in FIG. 1, the detection device (120) is communicatively coupled to the sensor (150) by the transmission medium (145). The transmission medium (145) can be any medium capable of carrying communications from the sensor (110) to the detection device (120), including but not limited to a coaxial cable, a fiber-optic cable, a conductive medium such as a wire, a phone line, a medium for propagating wireless communications, and the like. In an exemplary embodiment, the transmission medium (145) is a conductive wire. In another exemplary embodiment, the transmission medium (145) is a wireless medium such as an infrared (IR) signal or a radio frequency (RF) signal.

As discussed above, the sensor (150) is coupled to the power transmission medium (135). The sensor (150) can be any device capable of detecting an electrical current, including but in no way limited to an inductor, an inductive coil or wire, a AC current detector, a current sensor or detector, and the like. In an exemplary embodiment, the sensor (150) is an AC current detector. The sensor (150) can detect electrical currents that are present in the power transmission medium (135) and transmit a signal that is associated with the level of current in the power transmission device (135) to the detection device (120) via the transmission medium (145).

Whenever the display device (130) is in a powered “on” state, the level of electrical current flowing from the power source (140) to the display device (130) is at a higher level than when the display device (130) is in a powered “off” state. The sensor (150) can detect different levels of electrical current as the current flows across the power transmission medium (135). The sensor (150) may be configured to detect changes in the electrical current. The sensor (150) can convert a detection of a flow of electrical current into a signal associated with the level of current flow in ways that are known in the art, such as using an inductive coil that produces a magnetic field in response to a flow of electrical current. The sensor (150) may then determine a signal, such as a voltage level, according to an attribute of the magnetic field. In an exemplary embodiment, the sensor (150) is an inductive wire coiled around the power transmission medium (135).

The detection device (120) can receive and process data transmitted by the sensor (150). By processing the data, the detection device (120) determines whether the power status of the display device (130) is “on” or “off.” The determination can be performed in a wide variety of ways, including processing any data associated with a detected electrical current, which data is indicative of a level of electrical current flowing to the display device (130). In an exemplary embodiment, the detection device (120) compares data associated with a detected electrical current to a predetermined threshold. If the data is less than the predetermined threshold, then the detection device (120) determines that the power status of the display device (130) is “off.” On the other hand, if the data is at or above the predetermined threshold, then the detection device (120) determines that the power status of the display device (130) is “on.” The predetermined threshold can be programmed into the detection device (120). The data or signal associated with the level of the electrical current can be processed by the sensor (150), by the detection unit (120), or by both the sensor (150) and the detection device (120).

In an exemplary embodiment, the detection device (120) is configured to power “on” or to transition to a “user active” state whenever the display device (130) is switched from a “power off” state to a “power on” state. The detection device (120) can determine that the display device (130) has been switched “on” when the level of detected electrical current switches from a level below the predetermined threshold to a level at or above the predetermined threshold. In one embodiment, the detection device (120) can be configured to transition to a state of lesser operability, such as a “standby mode,” whenever all of the display devices, to which the detection device (120) is communicatively coupled, are in a “power off” state.

Although FIG. 1 shows one head-end unit (110), one detection device (120), one display device (130), one power source (140), and one sensor (150) for illustrative purposes, it will be clear to one of ordinary skill in the art that the present system and method contemplates that the setup (100) can include more than one of each item, including a wide variety of different combinations of devices. In an exemplary embodiment, the head-end unit (110) interfaces with multiple detection devices (120). In an exemplary embodiment, the detection device (120) is coupled to multiple display devices (130).

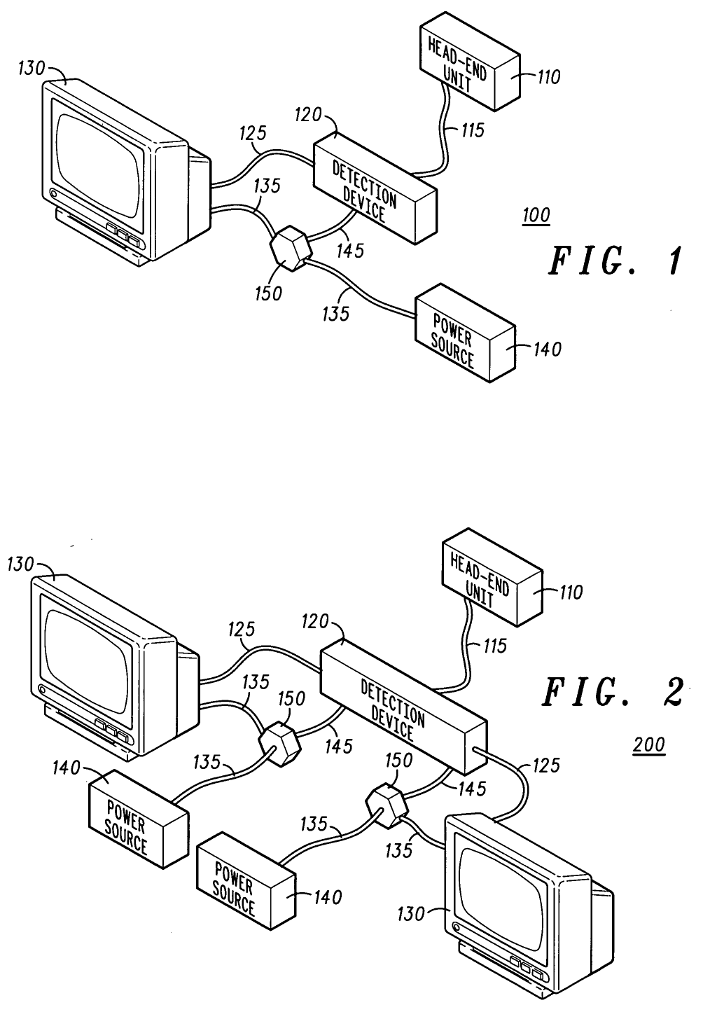

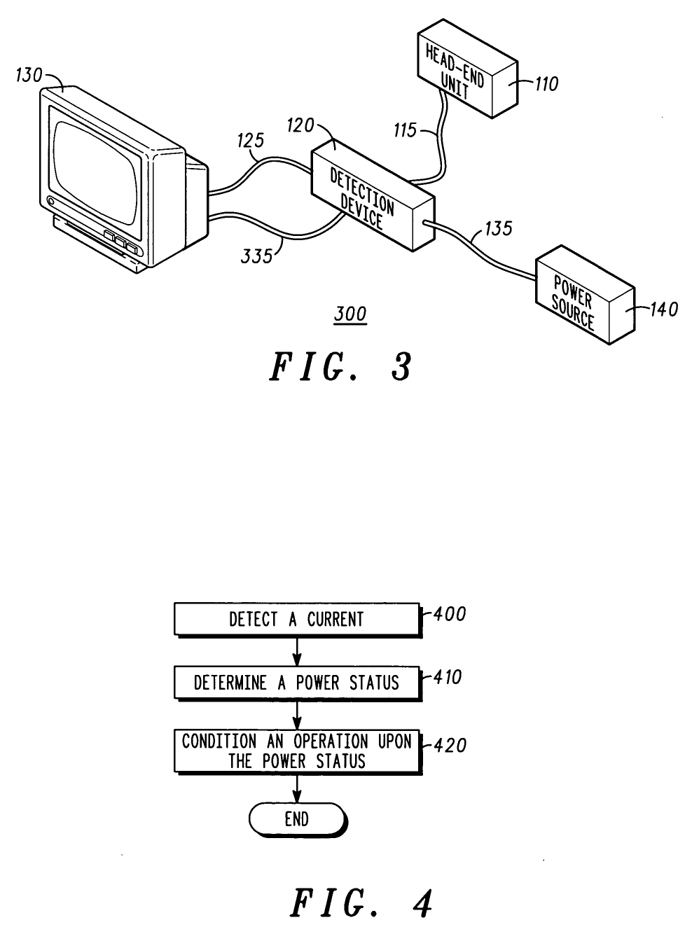

FIG. 2 shows an exemplary setup (200) of one detection device (120) configured to provide services to and to detect the power statuses of two display devices (130). As shown in FIG. 2, the head-end unit (110) is coupled to the detection device by the transmission medium (115). The detecition device (120) is configured to two display devices (130) by transmission mediums (125). The display devices (130) are each coupled to a power source (140) by power transmission mediums (135). The detection device (120) is coupled to two sensors (150) by transmission mediums (145), which sensors (150) are coupled to the power transmission mediums (135).

The operability of the setup shown in FIG. 2 is similar to that discussed in relation to FIG. 1. Further, the detection device (120) can be configured to share its resources between the display devices (130) according to the detected power statuses of the display devices (130). For example, if the first display device is “off,” the detection device (120) can freely tune to a channel that is requested by a user watching the second display device (130) without interrupting any viewing of the first display device (130). In an exemplary embodiment, two detection devices (120) are configured to provide services to three display devices (130) by sharing resources.

FIG. 3 shows another exemplary setup (300) of a system configured to determine a power status of a display device (130). As shown in FIG. 3, the head-end unit (110) is communicatively coupled to the detection device (120) by the transmission medium (115). The detection device (120) is communicatively coupled to the display device (130) by the transmission medium (125). The detection device (120) is coupled to the power source (140) by the power transmission medium (135). The display device (130) is coupled to the detection device (120) by a power transmission medium (335). The power transmission medium (335) can be any medium capable of transmitting power, such as electrical power, from the detection device (120) to the display device (130), including but not limited to a power cord, a wire, a conductive medium, and the like.

The detection device (120) can be configured to detect electrical currents associated with the display device (130). The detection device (120) may use the sensor (150; FIG. 1) to internally detect the currents. The detection device (120) can be configured or programmed to detect changes in electrical currents that occur when the display device (130) is powered “on” or “off.” For example, when the display device (120) is switched to “on,” it draws more current from the power source (140) through the detection device (120). The detection device (120) can be configured to detect changes to the level of current being drawn from the power source (140) and determine, according to the change in current draw, whether the power status of the display device (130) is “on” or “off.”

Similar to FIG. 1, FIG. 3 shows one head-end unit (110), one detection device (120), one display device (130), and one power source (140). This is for illustrative purposes, and it will be clear to one of ordinary skill in the art that the present system and method contemplates that the setup (100) can include more than one of each item, including a wide variety of different combinations of devices. In an exemplary embodiment, detection device (120) is coupled to multiple display devices (130). In an exemplary embodiment, the head-end unit (110) interfaces with multiple detection devices (120).

Exemplary Implementation and Operation

FIG. 4 shows an exemplary method for determining a power status of a display device. As illustrated in FIG. 4, the present method begins by detecting a current (step 400), such as an electrical current, that is associated with a display device (130; FIG. 1). The detection can be performed in any of the ways discussed above such as induction or detecting changes in current draws. In an exemplary embodiment, a sensor (150; FIG. 1) detects the current that flows from a power source to the display device (130; FIG. 1). A signal that is representative of the level of detected current is transmitted from the sensor (150; FIG. 1) to the detection device (120; FIG. 1).

FIG. 4 shows that the following step includes determining a power status (step 410) of the display device (130; FIG. 1) in accordance with the detected current. This determination can be made in any of the ways discussed above, including but not limited to comparing the level of detected current with a predetermined threshold. This step (410) can also include determining a change in the power status of the display device (130; FIG. 1). The detection device (120; FIG. 1) can monitor the flow of current to the display device (130; FIG. 1) and detect any changes that are significant enough to represent a change in the power status of the display device (130; FIG. 1). For example, when the display device (130; FIG. 1) is switched “on,” the current level increases from a level below a predetermined threshold to a level at or above the predetermined threshold.

As shown in FIG. 4, the next step includes conditioning an operation upon the power status (step 420) of the display device (130). The detection device (120; FIG. 1) can condition any number of or combination of its operations upon the determined power status of an associated display device (130; FIG. 1). The detection device (120; FIG. 1) can power “on” when the power status of the display device (130; FIG. 1) is switched from “off” to “on.” The detection device (120; FIG. 1) may be configured to switch into a “rest mode” when the power status of the display device (130; FIG. 1) is switched from “on” to “off.” Transmissions of messages, reminders, or programming services from the detection device (120; FIG. 1) to the display device (130; FIG. 1) can be conditioned upon the power status of the display device (130; FIG. 1). For example, the detection device (120; FIG. 1) can abstain from transmitting messages, reminders, or programming services to a display device (120; FIG. 1) when the power status of the display device (130; FIG. 1) is “off.” These conditions promote the saving of energy and the efficient allocation of resources.

Other operations can be conditioned upon the power status (step 420) of the display device (130; FIG. 1). The resources of the detection device (120; FIG. 1) can be allocated for use by other entities, such as other display devices (130; FIG. 1). For example, the detection device (120; FIG. 1) that provides signals to multiple display devices (130; FIG. 1) can safely tune to a different programming channel per the request of one display device (130; FIG. 1) when the power statuses of the other connected display devices are “off.” Such a reallocation of programming services to one display device (130; FIG. 1) is safe because the other display devices (130; FIG. 1) are “off,” and therefore are not being viewed. Further, download channels can be conditioned upon the power statuses of associated display devices (130; FIG. 1). When the display devices are known to be “off,” code and messages can be downloaded over faster in-band channels rather than slower out-of-band channels because the switch to a download channel will not interrupt the program viewing.

The method shown in FIG. 4 is illustrative. The steps shown can be modified, or additional steps may be added. For example, the power status of the display device (130; FIG. 1) can be made accessible to the head-end unit (110; FIG. 1) for use by a network operator. Thereby, the network operator can be provided with end-of-line diagnostic information. The network operator could access the detection devices (120; FIG. 1) on a network when their associated display devices (130; FIG. 1) are “off” so as to avoid interrupting the viewing of programming services by subscribers. In an exemplary embodiment, the conditioning of an operation upon a power status (step 420) is not necessary.

In conclusion, the present method and system for detecting a power status of a display device, in its various embodiments, allows for greater flexibility in operations of a detection device, such as a set-top box, in a service network. Specifically, the present method and system provides for determining a power status of a display device based on an electrical current associated with the display device. The determination provides for increased flexibility in the operations of set-top boxes by allowing for the conditioning of some operations upon the power statuses of display devices.

The preceding description has been presented only to illustrate and describe the present method and system. It is not intended to be exhaustive or to limit the present method and system to any precise form disclosed. Many modifications and variations are possible in light of the above teachings.

The foregoing embodiments were chosen and described in order to illustrate principles of the method and system as well as some practical applications. The preceding description enables others skilled in the art to utilize the method and system in various embodiments and with various modifications as are suited to the particular use contemplated. It is intended that the scope of the method and system be defined by the following claims.

1. A method for determining a power status comprising:
detecting a current associated with a power source of a display device; and
determining said power status of said display device in accordance with said current.

2. The method of claim 1, wherein said display device is one of a television and a digital video recorder.

3. The method of claim 1, further comprising transmitting said power status to a head-end unit.

4. The method of claim 1, further comprising conditioning a transmission of a signal to said display device upon said power status.

5. The method of claim 1, further comprising providing for a download of data by an in-band frequency if said power status indicates that said display device is off.

6. The method of claim 1, further comprising adjusting transmission of at least one of a message, a reminder, and a programming signal based on said power status.

7. A system for determining a power status comprising:
a display device;
a sensor configured to detect a current associated with a power source of said display device; and
a detection device communicatively coupled to said display device and to said sensor, wherein said detection device is configured to determine said power status of said display device in accordance with said current.

8. The system of claim 7, wherein said detection device is a set-top box configured to process television services.

9. The system of claim 7, wherein said display device is one of a television and a digital video recorder.

10. The system of claim 7, further comprising a head-end unit configured to access data associated with said power status of said display device.

11. The system of claim 7, wherein said detection device is configured to power on if said power status indicates that said display device transitions from an off state to an on state.

12. The system of claim 7, wherein said detection device is configured to switch to a standby mode if said power status indicates that said display device transitions from an on state to an off state.

13. The system of claim 7, wherein said detection device is configured to adjust transmission of at least one of a message, a reminder, and a programming signal if said power status indicates that said display device is off.

14. The system of claim 7, wherein said detection device is configured to download data from a head-end unit by an in-band frequency if said power status indicates that said display device is off.

15. A system for determining a power status comprising:
a detection means communicatively coupled to a display means; and
a sensing means communicatively coupled to said detection means, said sensing means being configured to detect a current associated with a power source of said display means;
wherein said detection means is configured to receive data associated with said current from said sensing means and to determine said power status of said display means in accordance with said data associated with said current.

16. The system of claim 15, wherein said detection means is a set-top box.

17. The system of claim 16, wherein said set-top box is configured to provide cable television services to said display means.

18. The system of claim 15, wherein said display means is one of a television and a digital video recorder.

19. A system for determining a power status comprising:
a first display device and a second display device;
a first sensor and a second sensor configured to detect a first electrical current associated with said first display device and a second electrical current associated with said second display device; and
a detection device communicatively coupled to said fist display device, said second display device, said first sensor, and said second sensor;
wherein said detection device is configured to receive data associated with said first electrical current and said second electrical current and to determine a first power status associated with said first display device and a second power status associated with said second display device in accordance with said data.

20. The system of claim 19, wherein said first display device is a television and said second display device is a television.

21. The system of claim 19, wherein said detection device is a set-top box configured to process cable television services.

22. The system of claim 19, wherein said detection device is configured to make a resource available to said second display device if said first power status indicates that said first display device is off.

23. The system of claim 22, wherein said resource is a tuner configured to receive a channel associated with television programming services.

24. The system of claim 19, further comprising a head-end unit, wherein said detection device is configured to download a data object from said head-end unit by an in-band frequency if said first power status indicates that said first display device is off and said second power status indicates that said second display device is off.

25. A processor-readable medium including processor instructions that instruct a processor to perform the steps of:
receiving a data signal associated with a current, said current being associated with a power source of a display device; and
determining a power status of said display device in accordance with said current.

26. The processor-readable medium of claim 25, wherein said determining said power status of said display device in accordance with said current includes comparing an attribute of said current to a predetermined threshold.

27. The processor-readable medium of claim 25, wherein said display device is one of a television and a digital video recorder.

28. The processor-readable medium of claim 25, further comprising transmitting said power status to a head-end unit.

29. The processor-readable medium of claim 25, further comprising conditioning a transmission of a signal to said display device upon said power status.
